(19) United States
(12) Patent Application Publication
(10) Pub. No.: US 2004/0050855 A1
(43) Pub. Date: Mar. 18, 2004

(54) Vending machine

(76) Inventor: Gordon Jurgenson, Walnut Creek, CA (US)

Correspondence Address: FISH & NEAVE, 1251 AVENUE OF THE AMERICAS, 50TH FLOOR, NEW YORK, NY, 10020-1105, US

(21) Appl. No.: 10/246,294

(22) Filed: Sep. 17, 2002

(51) Int. Cl. G07F 11/00

(52) U.S. Cl. 221/80

(57) ABSTRACT

Automated vending machine that can hold a large number of items while occupying only a small footprint. The main elements of the device are a hollow housing comprised of item loading and dispensing openings. Mounted within the housing is a motor-driven conveyor to which are affixed a plurality of item mounts, each mount associated with one of plurality of item identifiers. A sensor keeps track of the items on the conveyor. Inputs to an interface mounted on the device signal a processor controllably coupled to the motor, item mounts, sensor and loading and dispensing opening.

The machine provides customers with multiple choices of tendering payment. An external communications device in the machine allows for communication between the vending machine and vendors.

### BACKGROUND OF THE INVENTION

This application relates to vending machines and methods for operating vending machines.

In many municipalities, publishers of printed items such as newspapers distribute their works through racks on public sidewalks or in private buildings and walkways. Current rack designs, however, present many problems. In many areas the number of racks has become so large that they obstruct sidewalk traffic—a problem made more acute when the wind, vehicles or vandals knock the racks over. In addition, most existing racks accommodate cash payments only, and do not offer vendors the ability to collect sales data.

Distribution of items such as compact discs (CDs) and digital versatile discs (DVDs) is also in need of improvement. Traditional stores are subject to shoplifting, as customers have access to the items before paying for them. The need for employees to guard against theft and to operate cash registers also creates considerable overhead. Finally, sales in traditional retail establishments are restricted to the times in which the retail establishments are open.

In view of the foregoing, it is an object of the present invention to reduce the physical foot print and clutter of existing vending devices, while at the same time permitting the secure vending of a large number of items.

It is also an object of the present invention to provide vendors with a cost-effective way to vend items 24-hours a day.

It is also an object of the present invention to provide vendors with useful sales and management information regarding the items vended and the vending device.

It is also an object of the present invention to provide customers with multiple choices for tendering payment, including by cash, credit card, smart card, and cellular telephone.

### SUMMARY OF THE INVENTION

These and other objects of the invention are accomplished in accordance with the principles of the invention by providing a secure, automated vending machine that can hold a large number of items while occupying only a small footprint. The vending machine may have a motorized item-holding conveyor mounted in a hollow housing. The machine may also provide customers with multiple options for tendering payment, including cash, credit card, smart card, and cellular telephone. A communications device may be used in the machine to enable vendors to communicate with the vending machine over external networks such as the Internet, and to retrieve data such as sales information and information regarding the status of the vending device.

Further features of the invention, its nature and various advantages will be more apparent from the accompanying drawings and the following detailed description of the preferred embodiments.

### BRIEF DESCRIPTION OF THE DRAWINGS

FIG. 1 is a front perspective view of a vending machine constructed in accordance with the present invention.

FIG. 2 is a rear perspective view of a vending machine constructed in accordance with the present invention.

FIG. 3 is an illustration of the processor, memory, modem (and software modules therein) that may be placed in the vending machine, and the way in which the modem may connect to an external network.

FIG. 4 is a front perspective illustration of a user interface unit that may be used with the vending machine in accordance with the present invention.

### DETAILED DESCRIPTION OF THE PREFERRED EMBODIMENTS

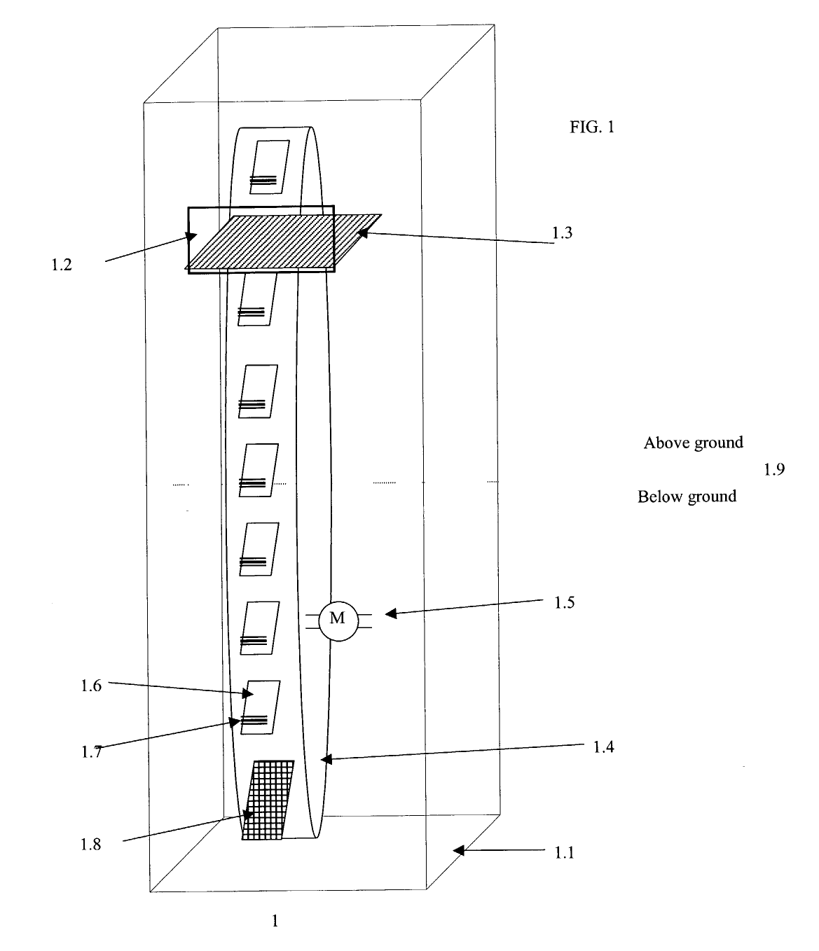

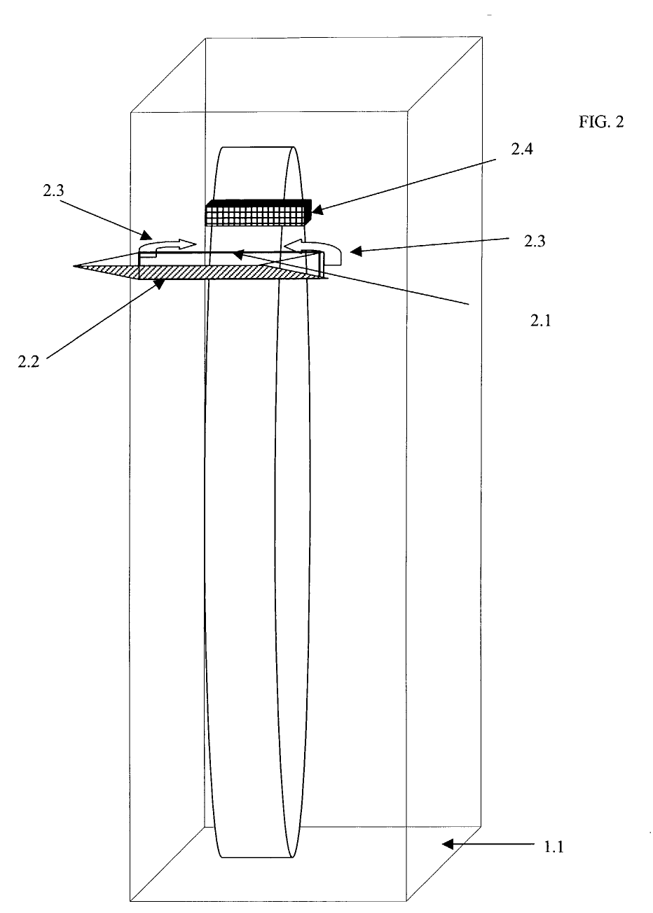

A vending machine 1 in accordance with the present invention is shown in FIG. 1. As illustrated, the vending machine 1 may have a hollow housing 1.1. The housing 1.1 may have an item dispensing opening 1.2 (FIG. 1) and an item loading opening 2.1 (FIG. 2). A motor-driven conveyor 1.4 may be mounted within the housing 1.1. A plurality of item mounts 1.6 may be fixed to the conveyor 1.4.

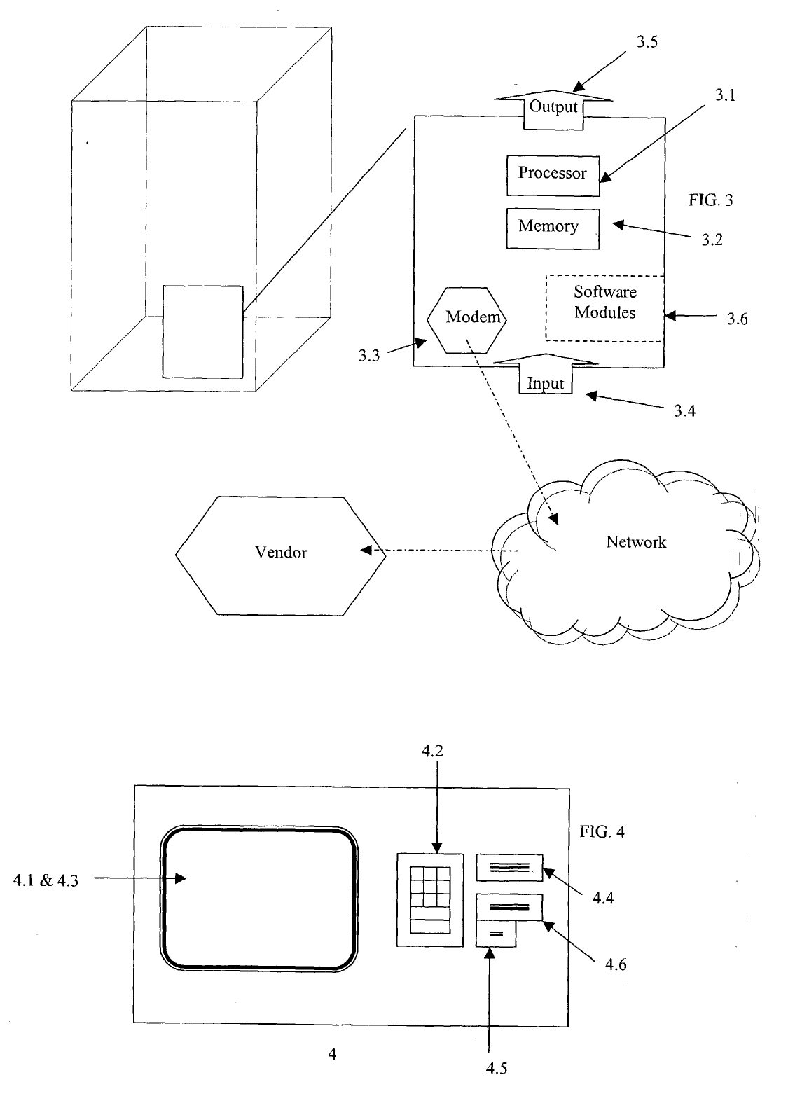

Each item mount 1.6 may be associated with one of a plurality of item identifiers 1.7. A motor 1.5 may be used to drive the conveyor 1.4 to various locations within the housing 1.1. The vending machine 1 may have a customer interface 4 (FIG. 4) and a processor 3.1 (FIG. 3) coupled to the motor 1.5. The processor 3.1 may control the motor 1.5 in response to inputs received from the customer interface 4. The processor 3.1 may also be used to control other vending machine 1 components such as the item mounts 1.6 and the loading and dispensing openings 1.2, 2.1.

The housing 1.1 may be of any suitable shape, size and orientation. The type of housing that is used in a given environment will depend largely on the items to be vended and general aesthetic concerns. The housing 1.1 shown in FIG. 1 is rectangular in shape, so that its horizontal top and bottom are shorter than its vertical sides. This type of arrangement may be used to limit the footprint of the vending machine. Housing 1.1 may be formed from any suitable materials such as metal, plastic or glass. If desired, however, the housing 1.1 may be made of a durable metal, so as to resist the elements and provide security to the machinery, items and money inside.

The vending machine 1 may be freestanding, bolted to the ground, set within a wall, or otherwise securely fixed to the side of a structure. The vending machine 1 may also be set within the ground, so that a substantial portion of the machine is under ground level. The dotted line 1.9 bisecting FIG. 1 illustrates the ground level, with part of the vending machine 1 residing above and part residing below the ground. The below-ground potion of the housing may be specially galvanized or reinforced.

The dispensing opening 1.2 may be mounted on the front of the housing 1.1, and be any suitable shape and size allowing the dispensing of an item. In the example of FIG. 1, a dispensing opening door 1.3 is mounted within the dispensing opening 1.2. In the illustrated embodiment, the dispensing opening 1.2 is at waist level so as to be easily reached by customers, and is only slightly larger in size than the dimensions of the folded end of a newspaper.

If desired, the item dispensing door 1.2 may open inward to form a chute for dispensed item. In an additional suitable arrangement, one opening may serve as both the item loading and dispensing opening.

The conveyor 1.4 may be mounted in the housing 1.1. The conveyor 1.4 may be mounted in a variety of orientations, including the vertical orientation illustrated in FIG. 1. The structure of the conveyor would depend upon the product being vended. A conveyor for items such as newspapers or CD's, for instance, may take the form of a plastic belt with teeth driven by a crank shaft. A conveyor for heavier items may be constructed of a roller chain. The conveyor 1.4 may be held in position by a series of rollers and tracks, and powered by motor 1.5.

A product conveyor which is similar in principle to the conveyor in this invention is already being used in a much larger application to move electrical coils and cables at retail hardware stores, or for storing carpet in many carpet warehouses.

The item mounts 1.6 may be spring clamps opened and closed by solenoids or air or hydraulic cylinders. The newspaper printing industry currently uses similar clamping devices to hold publications as they move through the printing and folding process.

The item loading opening 2.1 may be of any suitable form and size to allow the loading of items into the vending machine 1, and may be placed anywhere on the housing 1.1. In the example of FIG. 2, mounted in the loading opening is a loading door 2.2 only slightly larger than the dimensions of the face of a folded newspaper. The opening is thus the minimum size necessary for loading such an item.

The loading door 2.2 in the loading opening 2.1 may open outward to serve as a guide to assist in the loading of the vending machine 1. This guiding function may, for instance, be accomplished by vertical planes attached to the sides of the loading door 2.2. In another alternative, fixed to the top of the loading door 2.2 would be a device similar to a book end that retracts as the door closes and is vertical when the door is horizontal. Items would be loaded onto the tray in a vertical position. The “book end” would apply tension or pressure to the items, which would cause the items to move toward the conveyor. The “book end” may apply pressure to the item in a variety of ways, including through a compression spring.

The loading door 2.2 may be secured by a lock (not shown) opened by key, combination, or electronic input.

The example of FIG. 2 further illustrates item loading hooks 2.3 that may be used to guide items into the item mounts 1.6. These loading hooks 2.3 may be mounted in close proximity to the loading opening 2.1. The loading hooks 2.3 hook and pull the item into position so that it may be fixed to an item mount 1.6.

Affixed to each item mount 1.6 may be an item identifier 1.7. A bar code may used for this purpose. Affixed within the housing 1.1 may be a scanner 1.8 similar to the type found in most retail stores.

The example in FIG. 2 illustrates an image capture device 2.4 mounted inside the housing 1.1, in close proximity to the loading opening 2.1. This image capture device may be a digital camera or a scanner that captures an image of the item loaded into the vending machine 1.

On the front or top of the housing 1.1 may be a customer interface unit 4, shown in FIG. 4. The customer interface unit may contain a screen 4.1 suitable for the display images of items contained in the vending machine, or to prompt and direct customers as to the vending procedure. The customer interface may contain a keypad 4.2 or touchscreen 4.3 through which the customer can select items. The example in FIG. 4 illustrates a suitable arrangement of these elements. The customer interface unit may also 4 contain additional security features such as fingerprint, handprint and retinal scanners in order to confirm the identity of a customer.

The vending machine 1 may also contain a payment collection device, which may include a credit card slot and magnetic reader 4.4, a coin chute 4.5, a paper bill acceptor 4.6, and/or a smart card reader and mechanism to receive payment by cellular telephone. Such payment collection devices are well known in the art, and used widely in such devices as automated teller machines and various kinds of automated kiosks.

As illustrated in the example of FIG. 3, a processor 3.1, memory 3.2, and input 3.4 and output 3.5 may be mounted inside the housing 1.1. These elements may run software modules 3.6 comprising a motor drive module for controlling the activation of the motor 1.5 and progress of the conveyor 1.4, an item mount control module for controlling the fixing and unfixing of the item to the item mount 1.6, a customer input module for processing customer item selection, a payment module for recognizing and processing customer payments for selected item, a dispensing module for controlling dispensing of the item, a loading module for controlling loading of the item, an inventory module for tracking the types and locations of the items loaded into the vending machine 1, a record-keeping module for maintaining a record of the transactions processed by the vending machine, and a security module for controlling electronic locks and storing and processing password information. Effecting an interface between the processor 3.1, the memory 3.2, the software 3.6, and the mechanical elements of the invention is readily implemented by those skilled in the art.

Finally, if desired the vending machine 1 may contain a communications device such as a modem 3.3 that facilitates communications between the vending machine 1 and external data networks such as the Internet or credit card processing networks. The modem 3.3 may also facilitate a direct connection to a remote facility.

In order to load items into the vending machine 1, a vendor may access the loading door 2.2 by opening the physical lock (not shown). The vendor may then input the identity and number of the items loaded. The vendor may input this information through the user interface unit 4, an additional interface unit near the loading opening 1.2, or through a user input device such as a processor attached to a communications port on the vending machine 1. The motor module then prompts the motor 3.1 to advance the conveyor 1.4 so that appropriate item mount 1.6 is positioned for loading.

The vendor may next insert the item into the guide created by the open loading door 2.2. An additional input by the vendor may signal the loading module, which prompts the item mount module to ready the item mount 1.6 to receive the item, and then directs the loading hooks 2.3 to guide the item into the item mount 1.6. Once the item is fixed to the item mount 1.6 the conveyor 1.4 advances to present the next item mount 1.6, and so forth. The record-keeping and inventory modules may associate each loaded item with the item mount 1.6 to which it is fixed. The processor 3.1 may locate the position of each item mount by use of the bar code scanner 1.8, which reads the tags 1.7 on the clamps 1.6 as they pass in front of the bar code scanner 1.8. A computer software module may also be used to track the movement of the conveyor, and thus the position of item mounts attached to the conveyor. During the process of loading, the inventory module may also record the identity and position of each item.

As the first item of any group of like items advances into the vending machine 1, the scanner or camera 2.4 may capture an image of the item. The image of the item may then be stored in the vending machine's 1 memory 3.2 for display on the device's screen 4.1.

The vending machine 1 may offer items to customers based on the inventory available, as tracked by the inventory module. Guided by images of the item and instructions and prompts on the screen 4.1, the customer may operate the buttons 4.2 or touchscreen 4.3 on the interface unit 4 to select the desired item. These inputs may then trigger the vending module, which in turn may prompt customer payment. After confirming that the customer has tendered payment via the credit card slot and magnetic reader 4.4, coin chute 4.5, paper bill acceptor 4.6, smart card reader or mechanism to receive payment by cellular telephone, the motor module may prompt the motor 1.5 to move the conveyor 1.4 so that selected item aligns with dispensing opening 1.2. The door module may then signal the dispensing door 1.3 to open inward, forming a chute. The item mount control module may signal the item mounts 1.6 to open, so that the item drops on the chute and out of the machine.

A vendor may contact processor 3.1 remotely through an external communications device such as a modem 3.3 connected to a network such as the Internet. The vendor may thus remotely check on such things as the status of vending machine 1 and its inventory. A vendor may also use this remote communication ability to set prices, update the processor programs loaded on the processor 3.1, and conduct similar administrative tasks.

It will be understood that the foregoing is merely illustrative of the principles of this invention, and that various modifications can be made by those skilled in the art without departing from the scope and spirit of the invention. The invention may, for instance, also be used in situations where controlled and recorded access is important. The onboard processor 3.1, software modules 3.6, and communication device may be used to access a database of prescriptions, so the invention may dispense prescribed drugs to approved individuals identified by credit card, access code or fingerprint, handprint, retinal scanner or other identification feature. The invention would then record the transaction, and transmit this information back to the central database. This is an improvement over drug stores in that it would permit drug distributors to reduce payroll, improve security, ease billing and provide drugs twenty-four hours a day. The invention could also be used to dispense items such as airline tickets to individuals whose identities the invention confirms. This would provide a secure, automated way to vend tickets to approved individuals.

What is claimed is:

1. A vending machine for vending items to customers, the device comprising:
(a) a housing having an opening for dispensing the items;
(b) a conveyor mounted in the housing, the conveyor having a plurality of item mounts for holding the items;
(c) a motor that drives the conveyor to position the item mounts at various locations inside the housing;
(d) a user interface unit that receives inputs from customers;
(e) a processor configured to control the motor to position the conveyor so that the item mount holding a desired item is presented at the dispensing opening.

2. The vending machine of claim 1, wherein the housing comprises a below ground portion for permitting more item storage space inside the housing than would be available in the above-ground portion alone

3. The vending machine of claim 1 further comprising an image capture device mounted within the housing and an image display screen mounted on the device that displays images of the items to customers.

4. The vending machine of claim 1, further comprising:
(a) a bar code reader mounted in the housing;
(b) a bar code tag fixed to each item mount;
(c) an inventory software module that interacts with a processor, wherein the barcode reader scans the bar code tags on the item mounts as they pass in front of the barcode reader to identify to the processor and the inventory software module the location of each item mount on the conveyor.

5. The vending machine of claim 1, further comprising a payment collection interface that allows customers to pay for the desired item using paper or coin money, or a credit card, debit card, smart card, or cellular telephone.

6. The vending machine of claim 1 further comprising a guide that directs an item loaded into the device onto a given one of the item mounts.

7. The vending machine of claim 1 further comprising a communication device that handles communications between the processor and an external communication network.

8. The vending machine of claim 1, further comprising:
(a) a processor with a record-keeping module to maintain a record of the transactions processed by the device and the current inventory in the device;
(b) an external communications device to communicate the transaction records and current inventory to an external network.

9. A vending machine for vending items to customers, wherein at least part of the vending machine is reinforced so that it may be placed underground.

10. A vending machine for vending items to customers, wherein at least part of the vending machine made of a galvanized metal so as to resist subterranean corrosion.

11. The vending machine of claims 9 or 10, the device further comprising:
(a) a housing having a dispensing opening in the above-ground portion of the vending machine for dispensing the item;
(b) a conveyor mounted in the housing, the conveyor having a plurality of item mounts;
(c) a processor with an record-keeping module to maintain a record of the inventory in the device, wherein the processor directs the conveyor to position an item mount at the dispensing opening.

12. A vending machine for vending items to a customer, comprising:
(a) a housing having an opening for dispensing items;
(b) a door in the housing that opens inward to form a chute for dispensing the items.

13. A vending machine for vending items to a customer, comprising:
(a) a housing having an opening for dispensing items;
(b) a door on the housing that opens to form a loading tray to guide the item into the device.

14. A method for vending items to customers from a vending machine, comprising:
(a) displaying the items contained in the vending machine to customers via a screen on the vending machine;
(b) providing customers with an interface through which the customers may select an item contained in the vending machine;
(c) in response to customers' selections, moving a conveyor so that an item mount holding the selected items align with a dispensing opening;
(d) signaling item mount to release selected item, so that the item is vended through a dispensing opening.

15. The method of claim 14, wherein the conveyor aligns the item mount holding the selected item with the dispensing opening by using a scanner to identify a bar code on the item mount corresponding to the selected item.

16. The method of claim 14, wherein:
(a) after the item is aligned with a dispensing opening, the item mount holding the product releases the product;
(b) simultaneous to the item mount's release of the item, the a door on the dispensing opening opens inward and acts as a chute so that the item falls on the chute and slides out of the device.

17. The method of claim 14, further comprising communicating with the device over an external network in order to set item prices.

18. A method for loading a vending device, comprising:
(a) opening a loading door and placing item on a loading door positioned to serve as a loading tray.
(b) using a data input means to indicate the type and number of items to be loaded into the device.
(c) moving the conveyor to the appropriate stopping position, so that an item mount selected to hold the item aligns with the item in the loading tray.
(d) using one or more guides mounted in the housing, guiding the item into the item mount.

19. A vending machine for vending items to customers, comprising:
(a) a user interface unit for receiving customer inputs selecting items;
(b) a conveyor mounted in the housing, the conveyor having a plurality of item mounts;
(c) a bar code tag fixed to each item mount;
(d) a bar code reader mounted in the vending machine, wherein the bar code reader identifies the item mount to which the customer-selected item is fixed.

20. A vending machine for vending items to a customer, comprising:
(a) a housing having a dispensing opening for dispensing items;
(b) a door mounted in the dispensing opening, the door opening inwards to form a chute;
(c) one or more payment collection interfaces for accepting payment for the items, wherein item is vended through the dispensing door chute once payment is made.
